(19) United States
(12) Patent Application Publication
(10) Pub. No.: US 2016/0084455 A1
(43) Pub. Date: Mar. 24, 2016

(54) LED lighting tube

(71) Applicant: HUNG-CHANG CHEN, Taipei City (TW)

(72) Inventor: HUNG-CHANG CHEN, Taipei City (TW)

(21) Appl. No.: 14/489,492

(22) Filed: Sep. 18, 2014

(51) Int. Cl. F21S 4/00; F21V 3/04; F21V 21/002; F21V 23/00

(52) U.S. Cl. CPC F21S 4/008; F21V 23/003; F21V 3/04; F21V 21/002; F21Y 2103/003

(57) ABSTRACT

A LED lighting tube contains: a body, an explosion-proof protecting film, a fixing member, a plurality of LED elements, and two caps. The body includes an outer wall and an inner wall, the explosion-proof protecting film covers the body, the fixing member includes at least one circuit layer electrically connected with two LED driving modules and an adhesive layer adhered with the inner wall of the body. The plurality of LED elements are arranged on the at least one circuit layer and are electrically connected with the two LED driving modules via the at least one circuit layer, the two caps are mounted on two ends of the body, and each cap has an electrical terminal set, wherein a first end of the electrical terminal set is electrically connected with an external power, and a second end of the electrical terminal set is electrically coupled with each LED driving module.

### FIELD OF THE INVENTION

The present invention relates to a LED lighting tube which contains a heat-conducting fixing member and an explosion-proof protecting film.

### BACKGROUND OF THE INVENTION

Referring to FIG. 1, a conventional LED lighting tube 1′ contains a body 10′, a cover 11′, a circuit board 13′, plural LED elements 14′, a LED driving module 12′, and two caps 15′. The circuit board 13′ and the plural LED elements 14′ are placed on the body 10′, the LED driving module 12′ is fixed in an accommodating chamber of the body 10′, the cover 11′ is covered on the body 10′, and the two caps 11′ are mounted on two ends of the body 10′. The circuit board 13′ is electrically connected with the LED driving module 12′ to control the plural LED elements 14′ to illuminate lights, and each cap 15′ has an electrical terminal set 151′ for connecting with supply mains.

However, the conventional LED lighting tube 1′ has disadvantages as follows:

1. The circuit board 13′ is placed on the body 10′, the LED driving module 12′ is fixed in the body 10′, and then the cover 11′ is covered on the body 10′, thereafter the two caps 15′ are mounted on two ends of the body 10′, thus producing the conventional LED lighting tube 1′ complicatedly.

2. The body 10′ is extruded from aluminum to cause a large size and high production cost.

3. A bottom end of the body 10′ exposes outside the cover 11′, so the conventional LED lighting tube 1′ has poor insulation effect.

4. The body 10′ occupies a certain area of the conventional LED lighting tube 1′, the plural LED elements 14′ transmits less omnidirectional lights (about 180°), thereby having less lighting range.

The present invention has arisen to mitigate and/or obviate the afore-described disadvantages.

### SUMMARY OF THE INVENTION

The primary object of the present invention is to provide a

LED lighting tube in which a fixing member is adhered with the inner wall of a body by using an adhesive layer, such that heat from a plurality of LED elements is dissipated to air via the body effectively.

Secondary object of the present invention is to provide a LED lighting tube in which the fixing member is adhered with an inner wall of the body tightly to transmit omnidirectional lights (about 300°) from the plurality of LED elements widely.

Further object of the present invention is to provide a LED lighting tube in which the body is a transparent glass tube or a transparent plastic tube to obtain insulation effect.

Another object of the present invention is to provide a LED lighting tube in which the explosion-proof protecting film covers the body to prevent fragmentation of the body, when the body is a glass tube.

To obtain the above objective, a LED lighting tube provided by the present invention contains: a body, an explosion-proof protecting film, a fixing member, a plurality of LED elements, and two caps.

The body is formed in a hollow tube shape and includes an outer wall and an inner wall.

The explosion-proof protecting film covers the outer wall of the body.

The fixing member includes at least one circuit layer electrically connected with two LED driving modules and includes an adhesive layer adhered with the inner wall of the body.

The plurality of LED elements are arranged on the at least one circuit layer and are electrically connected with the two LED driving modules via the at least one circuit layer, such that the two LED driving modules control the plurality of LED elements to illuminate lights via the at least one circuit layer.

The two caps are mounted on two ends of the body, and each cap has an electrical terminal set, wherein a first end of the electrical terminal set is electrically connected with an external power, and a second end of the electrical terminal set is electrically coupled with each LED driving module.

### BRIEF DESCRIPTION OF THE DRAWINGS

FIG. 1 is a perspective view showing the exploded components of a conventional LED lighting tube.

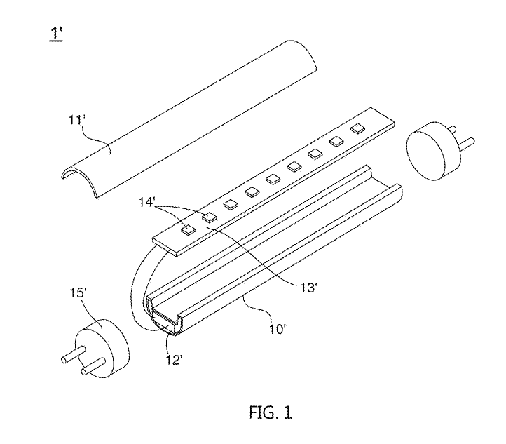

FIG. 2 is a perspective view showing the exploded components of a LED lighting tube according to a preferred embodiment of the present invention.

FIG. 3 is a side plan view showing the assembly of the LED lighting tube according to the preferred embodiment of the present invention.

FIG. 4 is a cross sectional view showing the assembly of the LED lighting tube according to the preferred embodiment of the present invention.

FIG. 5 is a flow chart of a method of making a LED lighting tube according to the preferred embodiment of the present invention.

FIG. 6A is a perspective view of making the LED lighting tube according to the preferred embodiment of the present invention.

FIG. 6B is a perspective view of making the LED lighting tube according to the preferred embodiment of the present invention.

FIG. 6C is a perspective view of making the LED lighting tube according to the preferred embodiment of the present invention.

FIG. 6D is a perspective view of making the LED lighting tube according to the preferred embodiment of the present invention.

FIG. 6E is a perspective view of making the LED lighting tube according to the preferred embodiment of the present invention.

### DETAILED DESCRIPTION OF THE PREFERRED EMBODIMENTS

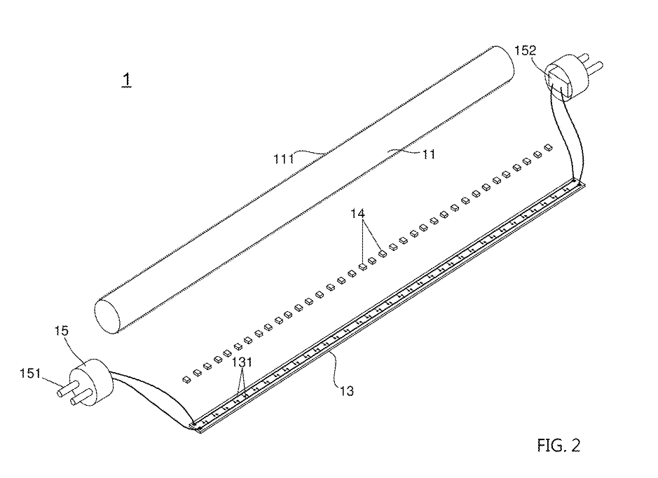

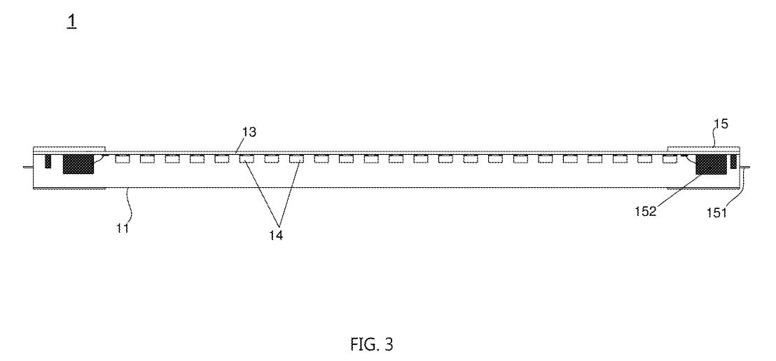

With reference to FIGS. 2 and 3, a LED lighting tube 1 according to a preferred embodiment of the present invention comprises: a body 11, an explosion-proof protecting film 111, a fixing member 13, a plurality of LED elements 14, and two caps 15. The body 11 is formed in a hollow tube shape and includes an outer wall and an inner wall; the outer wall of the body 11 is covered by the explosion-proof protecting film 111 to prevent fragmentation of the body 11.

The fixing member 13 includes at least one circuit layer 131 electrically connected with two LED driving modules 152 and an adhesive layer 132 adhered with the inner wall of the body 11.

The plurality of LED elements 14 are arranged on the at least one circuit layer 131 and electrically connect with the two LED driving modules 152 via the at least one circuit layer 131, such that the two LED driving modules 152 control the plurality of LED elements 14 to illuminate lights via the at least one circuit layer 131. The fixing member 13 is any one of a substrate, a fiberglass panel, an aluminum plate, a copper substrate, a flexible printed circuit board (FPC board), a ceramic substrate, and a printed circuit board (PCB). The adhesive layer 132 is disposed on a back surface of the fixing member 13 and is made of thermally conductive adhesive, silica gel, acrylic adhesive, adhesive, glue, sticky paste, adhesives, and other adhesive substance, such that the adhesive layer 132 is adhered with the inner wall of the body 11, and the at least one circuit layer 131 is a copper circuit layer or a circuit board. The plurality of LED elements 14 are arranged on the at least one circuit layer 131 and electrically connect with the two LED driving modules 152 in the two caps 15 via the at least one circuit layer 131, such that the two LED driving modules 152 control the plurality of LED elements 14 to illuminate the lights via the at least one circuit layer 131. In addition, the two caps 15 are mounted on two ends of the body 11, and each cap 15 has an electrical terminal set 151, wherein a first end of the electrical terminal set 151 is electrically connected with an external power, and a second end of the electrical terminal set 151 is electrically coupled with each LED driving module 152.

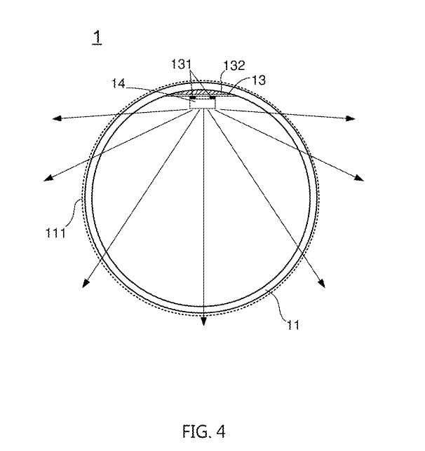

As shown in FIG. 3, each LED driving module 152 is accommodated in each cap 15, but it can be also mounted outside each cap 15. Referring further to FIG. 4, the at least one circuit layer 131 and the plurality of LED elements 14 are adhered on the inner wall of the body 11 by using the adhesive layer 132, such that heat from the plurality of LED elements is dissipated to air via the body 11 effectively. Preferably, the fixing member 13 is adhered with the inner wall of the body 11 tightly to transmit omnidirectional lights (about 300°) from the plurality of LED elements 14 widely.

The body 11 is a transparent glass tube or a transparent plastic tube. Preferably, the body 11 is a light-diffusing glass tube, a light-diffusing plastic tube or a heat-conducting light-diffusing plastic tube to transmit the lights widely. When the body 11 is the transparent glass tube, a light-diffusing explosion-proof protecting film 111 is covered on the body 11. When the body 11 is the light-diffusing glass tube, a transparent explosion-proof protecting film 111 is covered on the body 11. However, when the body 11 is the transparent plastic tube, the explosion-proof protecting film 111 is eliminated from the body 11 to save production cost.

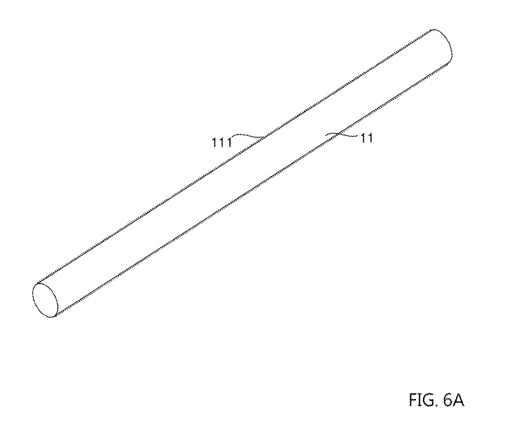

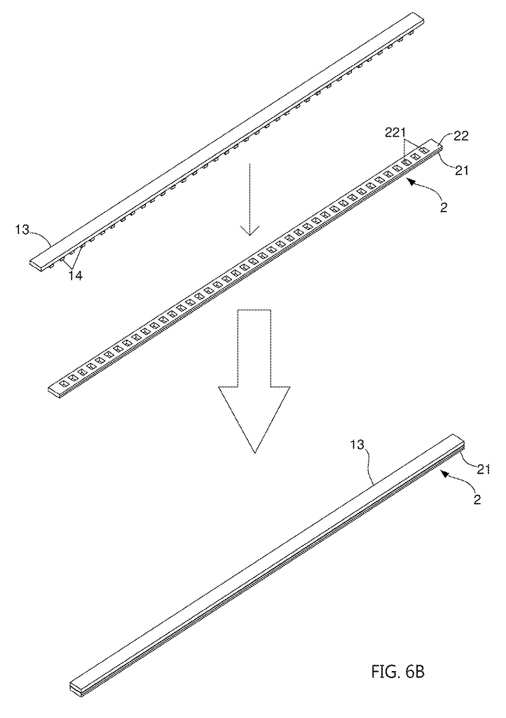

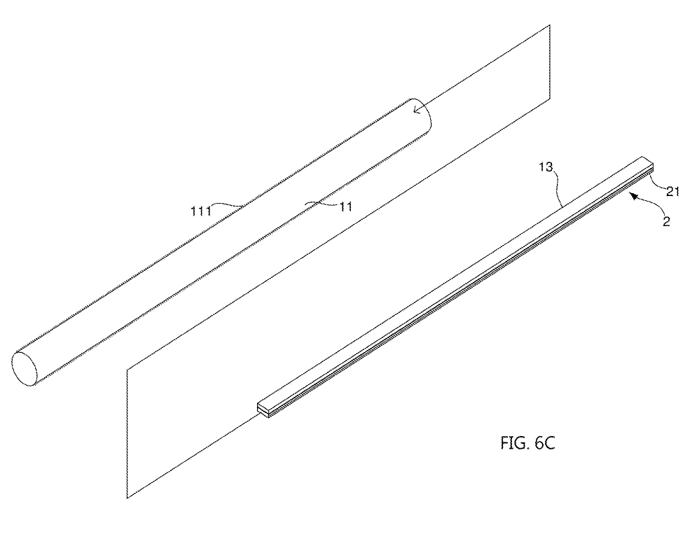

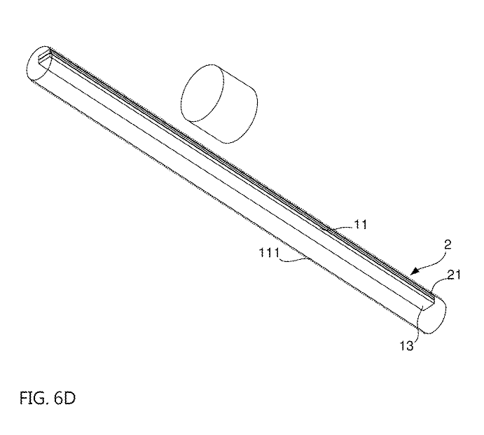

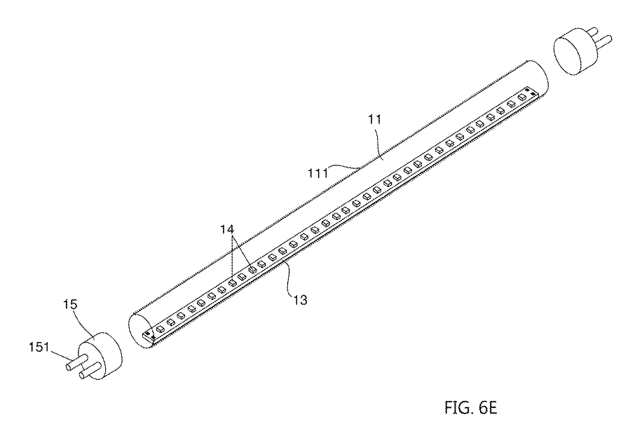

As illustrated in FIGS. 6A to 6E, a method of making the LED lighting tube comprises steps of:

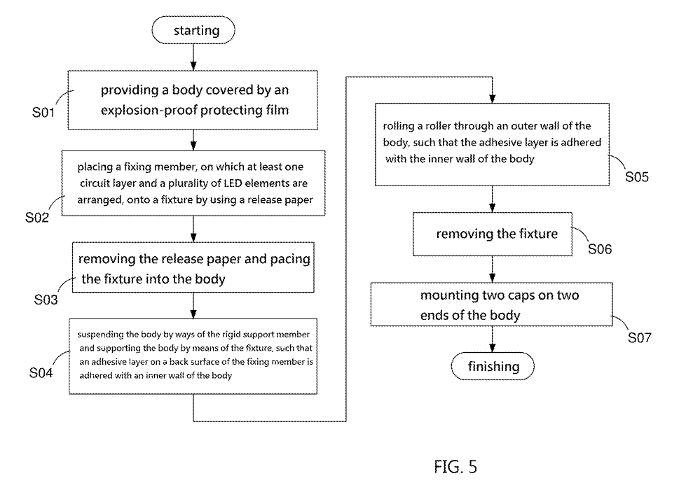

S01. providing a body 11 covered by an explosion-proof protecting film 111, as shown in FIGS. 5 and 6A;

S02. placing a fixing member 13, on which at least one circuit layer 131 and a plurality of LED elements 14 are arranged, onto a fixture 2 by using a release paper, wherein the fixture 2 is comprised of a rigid support member 21 and a flexible connecting member 22, the rigid support member 21 is applied to support and suspend the body 11, and the flexible connecting member 22 is fixed on the rigid support member 21 and has plural recesses 221 for accommodating the plurality of LED elements 14 as the fixing member 13 is placed on the fixture 2, as illustrated in FIG. 6B;

S03. removing the release paper and pacing the fixture 2 into the body 11, as shown in FIG. 6C;

S04. suspending the body 11 by ways of the rigid support member 21 and supporting the body 11 by means of the fixture 2, such that an adhesive layer 132 on a back surface of the fixing member 13 is adhered with an inner wall of the body 11;

S05. rolling a roller through an outer wall of the body 11, as illustrated in FIG. 6D, such that the adhesive layer 132 is adhered with the inner wall of the body 11, as illustrated in 6D;

S06. removing the fixture 2, as shown in FIG. 6E;

S07. mounting two caps 15 on two ends of the body 11, as shown in FIG. 6E.

Thereby, the LED lighting tube and the method of making thereof have advantages as follows:

The fixing member 13 is adhered with the inner wall of the body 11 by using the adhesive layer 132, such that the heat from the plurality of LED elements 14 is dissipated to the air via the body 11 effectively.

The fixing member 13 is adhered with the inner wall of the body 11 tightly to transmit the omnidirectional lights (about 300°) from the plurality of LED elements 14 widely.

The body 11 is the transparent glass tube or the transparent plastic tube to obtain insulation effect.

The explosion-proof protecting film 111 covers the body 11 to prevent the fragmentation of the body 11, when the body is the transparent glass tube.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A LED lighting tube comprising:
a body formed in a hollow tube shape and including an outer wall and an inner wall;
an explosion-proof protecting film covering the outer wall of the body;
a fixing member including at least one circuit layer electrically connected with two LED driving modules and an adhesive layer adhered with the inner wall of the body;
a plurality of LED elements arranged on the at least one circuit layer and electrically connected with the two LED driving modules via the at least one circuit layer, such that the two LED driving modules control the plurality of LED elements to illuminate lights via the at least one circuit layer;
two caps mounted on two ends of the body, and each cap having an electrical terminal set, wherein a first end of the electrical terminal set is electrically connected with an external power, and a second end of the electrical terminal set is electrically coupled with each LED driving module.

2. The LED lighting tube as claimed in claim 1, wherein the two LED driving modules are mounted in the two caps.

3. The LED lighting tube as claimed in claim 1, wherein the two LED driving modules are mounted outside the two caps.

4. The LED lighting tube as claimed in claim 1, wherein the body is a glass tube or a plastic tube.

5. The LED lighting tube as claimed in claim 4, wherein the glass tube is a transparent glass tube or a light-diffusing glass tube.

6. The LED lighting tube as claimed in claim 4, wherein the plastic tube is any one of a transparent plastic tube, a light-diffusing plastic tube, and a heat-conducting light-diffusing plastic tube.

7. The LED lighting tube as claimed in claim 1, wherein the explosion-proof protecting film is a light-diffusing explosion-proof protecting film or a transparent explosion-proof protecting film.

8. The LED lighting tube as claimed in claim 1, wherein the fixing member is any one of a substrate, a fiberglass panel, an aluminum plate, a copper substrate, a flexible printed circuit board (FPC board), a ceramic substrate, and a printed circuit board (PCB).

9. The LED lighting tube as claimed in claim 1, wherein the adhesive layer is disposed on a back surface of the fixing member and is made of any one of thermally conductive adhesive, silica gel, acrylic adhesive, adhesive, glue, sticky paste, adhesives, and adhesive substance.
